(19) United States
(12) Patent Application Publication
(10) Pub. No.: US 2017/0280930 A1
(43) Pub. Date: Oct. 5, 2017

(54) Microwavable Cooking Sheet, System and Method

(71) Applicant: Simple Wise Designs, LLC, Larkspur, CO (US)

(72) Inventors: Abe Johnson, Larkspur, CO (US); Keith L. Johnson, Ferndale, WA (US)

(21) Appl. No.: 15/630,756

(22) Filed: Jun. 22, 2017

Related U.S. Application Data
(63) Continuation of application No. 14/508,441, filed on Oct. 7, 2014, now abandoned.
Application No. 14/508,441 is a continuation-in-part of application No. 14/456,167, filed on Aug. 11, 2014, now abandoned.
Application No. 14/456,167 is a continuation of application No. 14/217,397, filed on Mar. 17, 2014, now abandoned.
(60) Provisional application No. 61/788,829, filed on Mar. 15, 2013.

(51) Int. Cl. A47J 36/02; B65D 81/34; B65D 65/02; B65H 16/00; B65B 25/22; B65B 11/00; H05B 6/80; A23L 5/10; B65D 65/46

(52) U.S. Cl. CPC A47J 36/027; A23L 5/15; B65D 81/3461; B65D 65/02; B65D 65/466; B65B 25/22; B65B 11/004; H05B 6/80; B65H 16/005; A23V 2002/00

(57) ABSTRACT

A cooking device, system and method are disclosed herein. In one embodiment, the method requires a microwavable cooking sheet to be provided, wherein the microwavable cooking sheet is comprised of a single layer of a primary material that is non-plastic and wherein the primary material has a weight of between 18 pounds per 3000 square feet and 60 pounds per 3000 square feet. The microwavable cooking sheet may be wetted and then wrapped completely around food to be cooked in a microwave. The food is cooked in the microwave with the wet microwavable cooking sheet wrapped around the food, such that a pressure increase of at least 3/16^{th} of an inch of H₂O is built-up within the microwavable cooking sheet.

### RELATED APPLICATIONS

This application (Attorney's Ref. No. P219243) is a continuation of U.S. patent application Ser. No. 14/508,441 filed Oct. 7, 2014, currently pending, the contents of which is incorporated herein by reference in its entirety.

U.S. patent application Ser. No. 14/508,441 is a continuation-in-part of U.S. patent application Ser. No. 14/456,167 filed Aug. 11, 2014, now abandoned, the contents of which is incorporated herein by reference in its entirety.

U.S. patent application Ser. No. 14/456,167 is continuation of U.S. patent application Ser. No. 14/217,397 filed Mar. 17, 2014, now abandoned, the contents of which is incorporated herein by reference in its entirety.

U.S. patent application Ser. No. 14/217,397 claims priority from U.S. Provisional Application Ser. No. 61/788,829 filed Mar. 15, 2013, now expired, the contents of which is incorporated herein by reference in its entirety.

### TECHNICAL FIELD

The present invention relates to cooking devices. In particular, but not by way of limitation, the present invention relates to a microwavable cooking sheet, which is used to cook food items, such as fresh, leftover and frozen foods.

### BACKGROUND

Fresh vegetables may be cooked using a steamer placed on a stovetop. In general, a steamer includes a pot of water with a porous container (e.g., a strainer or colander) that is suspended above the water. In use, the water in the pot is heated using the stovetop until it is brought to a boil. Then, a lid is placed over the pot (and container), which causes the internal temperature of the steamer to build. After about a minute, the lid is removed, vegetables are placed into the container, and the lid is loosely placed over the pot (and container), which allows the steam to escape. The amount of time necessary to cook each type of vegetable is dependent on its size and thickness.

Food cooked for an appropriate amount of time using a steamer often has bright colors (e.g., in the case of broccoli), is not dried out and has a relatively consistent texture. However, the process of steaming vegetables (or other food) can be time consuming and requires a pot to be cleaned, a colander to be cleaned and a lid to be cleaned.

As alternatives (or in some cases supplements) to stovetops and conventional ovens, microwave ovens (commonly referred to as microwaves) were created. Microwave ovens heat food by passing microwave radiation through it. Among other things, water in the food absorbs microwave energy in a process called dielectric heating, thereby cooking or warming the food. Microwaves are useful because they generally decrease cooking times, as compared to stovetops and conventional ovens.

Microwave ovens have been in widespread use since at least the mid-1980's. Fresh or leftover foods to be cooked in a microwave oven are generally placed in a microwave safe dish before being cooked. In some cases, foods are left uncovered while being cooked. In other cases, foods are covered with paper towels, semi-rigid vented plastic covers, rigid glass covers or otherwise microwave-safe rigid covers.

Certain frozen foods to be cooked in a microwave oven (e.g., frozen mixed vegetables) have also been cooked in a manner similar to fresh and leftover foods. However, in the case of “frozen dinners,” which include a plastic or paper tray and are covered by a thin sheet of plastic, the cook is asked to place a slit in the plastic cover or detach it from the tray to create an opening, so as to allow any steam to vent through the slit or opening.

Despite being prevalent for more than 30 years, cooking foods (e.g., fresh, leftover and frozen foods) in microwave ovens often results in the foods having significantly inferior taste, color, or texture, as compared to foods cooked on a stovetop or in a conventional oven. Many times, foods are cooked unevenly, regardless of whether they are covered or uncovered. For example, in some cases, food is cooked properly on the inside, but the outside is either undercooked or dried out. In other cases, food is properly cooked on the outside, but overcooked or undercooked on the inside (e.g., there may be hot and cold spots). While some have recognized the longstanding problem of foods cooked in microwave ovens as being inferior in taste, color, or texture, until now, no one has been able to adequately solve such problem.

Some have tried to solve the problem using paper towels that are wrapped around food being cooked in a microwave oven. For example, at least one individual has devised a system which involves dampening paper towels, squeezing out excess water so that the towels are moist but not dripping wet, wrapping food (e.g., asparagus) completely in the paper towels, laying the food in a microwaveable plate with the seam side down, and then microwaving the food. As another example, at least one individual has devised a system for cooking a potato, which involves washing a potato, poking holes in the potato, wetting a paper towel, wrapping the potato in the wet paper towel, placing the wrapped potato on a microwaveable plate, and then microwaving the potato.

Paper towels are disadvantageous because they have multiple layers and are designed for absorbency. When using paper towels for microwave cooking, it is extremely difficult to achieve an appropriate moisture balance for proper cooking.

When paper towels have too much moisture for a given food, as the food cooks, the microwave energy will tend to vaporize the water in the outer layer of the paper towel which has minimal effect on the cooking the food and also has some evaporative cooling effect on the inner layer of the paper towel, so the water on the inside layer of the paper towel will tend to remain as hot water instead of vapor for a relatively long period of time. Because of this, there is insufficient steam (or water vapor) on the inside of the paper towel near the food to cause it to be properly cooked. When wet paper towels have an insufficient amount of moisture for a given food, as the food cooks, the moisture will leave both layers of the paper towel entirely, before the food is done cooking, which will cause the outside of the food to overcook and dry out. Therefore, this cooking method (using wet paper towels) is very difficult to use for nearly all foods, and will only function well for certain foods with a moisture content that is suitable.

Furthermore, there are some foods which simply cannot be properly cooked using a wet paper towel because such foods do not have a significant enough internal moisture content. This is because the inner portion will cook quicker than the time it takes for the outside to cook due to the effects mentioned above.

At least one individual has tried to solve the aforementioned problem using a bag made of 100% cotton fabric, cotton batting and cotton flannel. The bag may be used for cooking a potato in a microwave oven that has a rotating turntable. The steps involve washing the potato, drying it with a paper towel, wrapping the potato in the damp paper towel used to dry the potato, placing the wrapped potato into the aforementioned bag, and then microwaving the potato. The individual warns that the bag should not be used over-and-over to cook many potatoes, as it may overheat and scorch or start a fire. Rather, the bag should be heated once and then be left to cool completely before it should be used again. According to the individual, the bag may also be used to cook sweet potatoes and corn on the cob. Furthermore, biscuits, rolls, tortillas and sweet rolls may be reheated using the bag.

In addition to the issues associated with paper towels described above, some of other the disadvantages of the bag include the fact that it may become soiled and, therefore, need washing. The individual suggests washing it, but not using fabric softener. If the soiled bag is not washed, it will begin to stink. Furthermore, due to its cost (as of 2014 the cost was $8.00 per bag), the bag would not traditionally be considered a one-time use (disposable) item.

In addition, the bag is not designed to cook a wide variety of food sizes, since it is a fixed size and is merely designed to be cinched at a one end. Further, it is not designed to be used with variable amounts of moisture and, due to having multiple layers (at least from the paper towel and bag), will experience similar types of evaporative effects as paper towels, which will cause the inner layer to remain relatively cool. This can lead to uneven cooking of the food.

Others have attempted to solve the problem by using one or more layers of plastic material to substantially enclose food in an effort to steam cook it. However, these solutions suffer from a number of disadvantages. For example, plastic bags that completely enclose the food are subject to rupture from the build-up of steam pressure inside the bag. To overcome this problem, other plastic bags require specialized venting mechanisms, which tend to be complex and difficult to regulate. Furthermore, although the use of plastic covers for frozen dinners has been widely used (in fact, the inventors have never seen any other material used as a cover for a frozen dinner), plastic is not an earth-friendly material because it is not biodegradable and, therefore, may be harmful to the environment. In addition, health concerns have been raised over the use of certain plastics in microwave ovens.

In view of the above, there is a need to develop a device that enhances the taste, color or texture of food cooked in a microwave oven relative to prior techniques. There is also a need for such a device to be biodegradable and disposable. There is also a need for such a device to be comprised of substantially a single layer of material for appropriate moisture control.

### BRIEF DESCRIPTION OF DRAWINGS

FIG. 1 illustrates a perspective view of one embodiment of an exemplary microwavable cooking sheet of the present invention with an exemplary food item to be cooked thereon;

FIG. 2 illustrates a side view of the microwavable cooking sheet of FIG. 1 with an exemplary food item to be cooked thereon;

FIG. 3 is a highly schematic view that illustrates that the microwavable cooking sheet is completely wrapped around the food item to be cooked, as shown by the ends of cooking sheet, although a portion of the cooking sheet is shown as being transparent for ease of understanding;

FIG. 4 is a highly schematic view (partially in cross-section) that illustrates that the food item to be cooked has been reoriented relative to FIG. 3, so that the overlapping ends of the microwavable cooking sheet are on the underside of the food item to be cooked and optionally placed in a bowl, which is shown in cross-section;

FIG. 5 is a view that illustrates another embodiment of the invention, wherein the food item to be cooked is placed in a bowl and the microwavable cooking sheet is wrapped around the food item to be cooked, such that the ends of the microwavable cooking sheet are under the bowl to completely contain the food item to be cooked between the microwave cooking sheet and the bowl;

FIG. 6 is a side view that illustrates another embodiment of the invention, which is similar to embodiment shown in FIG. 4, except that the bowl has water therein and the microwavable cooking sheet is in contact with the water in the bowl;

FIG. 7 is a side view that illustrates yet another embodiment of the invention, which is similar to the embodiment shown in FIG. 6, except that the microwavable cooking sheet is suspended above the water by a porous suspension mechanism and the container is both larger and taller than the bowl;

FIGS. 8 and 9 are side views that illustrate an additional embodiment of the invention, which is similar to the embodiment shown in FIG. 7, except that the container includes an annular ring which engages the microwavable cooking sheet to completely contain the food item to be cooked between the microwavable cooking sheet and the container;

FIG. 10 illustrates yet a further embodiment of the invention, wherein the microwavable cooking sheet is affixed to the tray of the frozen dinner;

FIGS. 11 and 12 are cross-sectional views that illustrate yet an even further embodiment of the invention, wherein the microwavable cooking sheet is wrapped around the tray of the frozen dinner, so that the food item(s) to be cooked are completely contained between the tray and the microwavable cooking sheet;

FIG. 13 is a perspective view that illustrates yet another exemplary embodiment of the invention, where the microwavable cooking sheet is in the form of an envelope;

FIG. 14 is a highly-schematic, partial cross-sectional view that illustrates a food tray (in cross-section) that has had its plastic cover removed and which has been inserted into the microwavable cooking sheet of FIG. 13 (shown as being transparent for ease of understanding in FIG. 14), so that the microwavable cooking sheet completely contains the food items to be cooked, which are located in the cooking tray;

FIG. 15 is a highly-schematic, partially transparent view showing food items to be cooked which have been inserted into the microwavable cooking sheet of FIG. 13, so that the microwave cooking sheet completely contains the food items to be cooked;

FIG. 16 is a top view of another embodiment of a microwavable cooking sheet that includes a primary material and an optional lattice attached thereto;

FIG. 17 is a cross-sectional view taken long line 17-17 of FIG. 16;

FIG. 18 is a view similar to FIG. 16, except that the size of the lattice is smaller in size relative to the size of the primary material of the microwavable cooking sheet;

FIG. 19 is a top view of yet a further embodiment of a microwavable cooking sheet that includes a primary material and an optional perforated plastic film attached thereto; and,

FIG. 20 is a view similar to FIG. 19, except that the size of the plastic film is smaller in size relative to the size of the primary material of the microwavable cooking sheet.

### SUMMARY

The present invention is designed to address at least one of the aforementioned problems and/or meet at least one of the aforementioned needs.

A cooking device, system and method are disclosed herein. In one embodiment, the method requires a microwavable cooking sheet to be provided, wherein the microwavable cooking sheet is comprised of a single layer of a primary material that is non-plastic and wherein the primary material has a weight of between 18 pounds per 3000 square feet and 60 pounds per 3000 square feet. The microwavable cooking sheet may be wetted and then wrapped completely around food to be cooked in a microwave. The food is cooked in the microwave with the wet microwavable cooking sheet wrapped around the food, such that a pressure increase of at least 3/16th of an inch of H₂O is built-up within the microwavable cooking sheet.

In one embodiment, the step of wetting the microwavable cooking sheet is performed prior to wrapping the microwavable cooking sheet around the food. In another embodiment, the step of wetting the microwavable cooking sheet is performed after wrapping the microwavable cooking sheet around the food.

In one embodiment, the step of wetting the microwavable cooking sheet includes providing a container having a liquid therein into which at least a portion of the microwavable cooking sheet is placed and wherein the microwavable cooking sheet has wicking properties, so that more than the portion of the microwavable cooking sheet that has been placed within the liquid becomes wet.

In one embodiment, the aforementioned pressure increase is observed after at least 60 seconds of cooking. In one embodiment, the food is cooked for a cooking time and the pressure increase occurs for more than 25% of the cooking time.

In one embodiment, the primary material of the microwavable cooking sheet is biodegradable. In one embodiment, the primary material of the microwavable cooking sheet is paper.

In one embodiment, a container having a porous support mechanism is provided. A liquid is also provided, wherein the liquid in the container that rests below the porous support mechanism. In this embodiment, the food wrapped in the microwavable cooking sheet is placed on the porous support mechanism prior to cooking.

Other objects, features, embodiments and advantages of the invention will be apparent from the following specification taken in conjunction with the following drawings.

### DETAILED DESCRIPTION

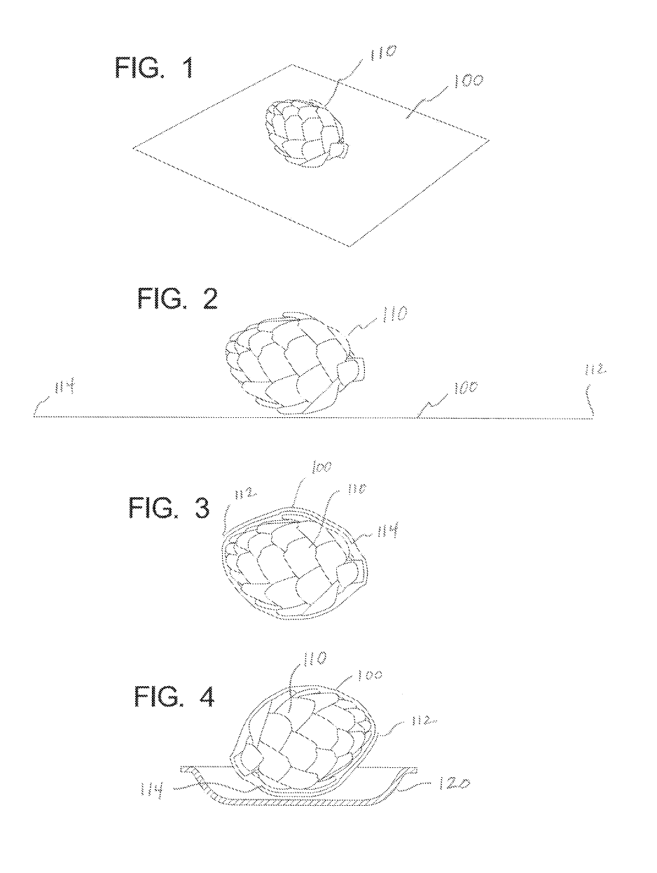

The present invention is directed to a microwavable cooking sheet, system and method. FIG. 1 illustrates a perspective view of one embodiment of an exemplary microwavable cooking sheet 100 of the present invention with an exemplary food item to be cooked 110 thereon. In one embodiment, the microwavable cooking sheet 100 is substantially planar and is, preferably, rectangular in shape. It should be understood that the shape of the microwavable cooking sheet 100 is not limited to a rectangular shape, but may take on a variety of different shapes (e.g., any polygon, an oval, a circle, and any symmetric or non-symmetric shape). Additionally, the microwavable cooking sheet 100 may include a wide variety of sizes. For example, the microwavable cooking sheet may be sized as a 9″×9″ square for use with a frozen dinner or may be sized as an 18″ diameter circle for use with an artichoke.

In one embodiment, the microwavable cooking sheets 100 are pre-cut, folded and sold a package of several sheets (e.g., in a stack). In one embodiment, the microwavable cooking sheets 100 are sold as single units. In one embodiment, the microwavable cooking sheets 100 are dispensed on a roll and have perforations indicating where a microwavable cooking sheet 100 should be torn from the roll. In one embodiment, the microwavable cooking sheets 100 are dry when packaged. In one embodiment, the microwavable cooking sheets 100 are wet when packaged. In one embodiment, a knife or blade is provided in conjunction with or as part of the package, so as to facilitate cutting of wet or dry microwavable cooking sheets 100 when necessary.

In one embodiment, the microwavable cooking sheet 100 is on a roll but does not include perforations. Instead, a sharp cutting tool (such as used with some aluminum foil rolls) is provided to cut the microwavable cooking sheet 100. By using a cutting tool, the microwavable cooking sheet 100 may be sized to correspond more closely with the size of the food item to be cooked 110.

In one embodiment, individual microwavable cooking sheets 100 are wrapped on a roll and don't include perforations. In such case, the microwavable cooking sheets may be conveniently dispensed without the need of a cutting tool and can be stored without the need of pulling each sheet through a package when needed. The individual cooking sheets 100 can be wrapped on the roll in such a manner that the end of a first microwavable cooking sheet slightly overlaps with the beginning of a next microwavable cooking sheet.

The microwavable cooking sheet 100 may be comprised of a disposable material such as, but not limited to, a fabric or other fibrous material. Examples of fabric or a fibrous material may comprise an organic material such as, but not limited to, one or more natural and/or man-made materials, such as pulp, porous paper, cellulose-based filter paper, crepe filter paper, an organic cotton or cotton blend, or may also comprise a woven polymeric organic blend material. Other flexible materials which may be adapted to absorb a liquid, and which are known in the art, are also contemplated. In one embodiment, the microwavable cooking sheet may comprise bamboo or a bamboo blend, an abaca blend, a banana blend, or a wood blend, or other natural fibrous materials. In one embodiment, the microwavable cooking sheet may comprise rayon-based fibers.

Preferably, the microwavable cooking sheet 100 is made of a material substantially similar to coffee filter paper. Accordingly, preferably, the microwavable cooking sheet 100 has a thickness substantially equal to that of coffee filter paper. In one embodiment, the microwavable cooking sheet 100 has a thickness from about 0.0015 inch to about 0.1 inch, more preferably from about 0.003 inch to about 0.065 inch, and even more preferably between 0.004 inch and 0.020 inch.

Preferably, the microwavable cooking sheet 100 is comprised of a single layer of material. Preferably, the microwavable cooking sheet 100 has a minimum weight basis of between 18 lbs./3000 sqft and a maximum weight basis of 60 lbs./3000 sqft, more preferably between 20 lbs./3000 sqft and 50 lbs./3000 sqft, and even more preferably between 28 lbs./3000 sqft and 40 lbs./3000 sqft.

As will be understood after reading the present disclosure and viewing the figures, the microwavable cooking sheet surrounds the food to be cooked either alone or in conjunction with one or more other items. Preferably, the microwavable cooking sheet 100 (either alone or in combination with the one or more items) is able to retain pressure of at least ⅛^{th} of an inch of water during at least 25% of the cooking process. More preferably, the microwavable cooking sheet 100 (either alone or in combination with the one or more items) is able to retain pressure of at least 3/16^{th} of an inch of water during at least 25% of the cooking process. Even more preferably, the microwavable cooking sheet 100 (either alone or in combination with the one or more items) is able to retain pressure of at least ¼ inch of water during at least 25% of the cooking process. In some embodiments, the above pressures are maintained for at least 35% of the cooking process. In yet other embodiments, the above pressures are maintained for at least 50% of the cooking process. In some embodiments, the above pressures are maintained for at least a period of time (e.g., 45 seconds, 60 seconds, or 90 seconds).

Preferably, the material used for the microwavable cooking sheet 100 meets FDA guidelines for food contact.

One use case of the present invention will now be described with reference to FIGS. 1-4. First, the microwavable cooking sheet 100 is wetted, for example, by placing it under a water faucet. Next, the microwavable cooking sheet 100 is wrung out. A user employs his or her judgment as to how damp the microwavable cooking sheet 100 should remain by estimating the relative water content of the food item to be cooked 110. In general, the lower the water content of the food item to be cooked 110, the wetter the microwavable cooking sheet 100 should be.

Next, as shown in FIGS. 1 and 2, the food item to be cooked 110 is placed substantially in the center of the microwavable cooking sheet 100. Subsequently, as shown in FIG. 3, the microwavable cooking sheet 100 is completely wrapped around the food item to be cooked 110, as shown by the overlapping position of the ends 112, 114 of the microwavable cooking sheet 100.

Next, as shown in FIG. 4, the food item to be cooked 110 is, preferably, reoriented relative its position in FIG. 3, so that the overlapping ends 112, 114 of the microwavable cooking sheet are on the underside of the food item to be cooked 110. At this point, the wrapped food item 110 may be placed in the microwave to be cooked. Optionally, as shown in FIG. 4, the wrapped food item 110 is placed in a bowl 120 and then placed in the microwave to be cooked.

The inventors have determined that the taste, color or texture of the food item being cooked in a microwave oven can be enhanced using a microwavable cooking sheet 100 as specified above. In essence, the microwave energy causes the food items to cook on the inside and causes steam to be captured around the outside of the food item due to the microwavable cooking sheet 100 retaining pressure. Accordingly, while the inside of the food item is being cooked via microwave energy, the outside of the food item is being cooked via steam at a similar rate as the inside. Pressure retention is also important since it helps increase the steam pressure slightly. Furthermore, it may help keep a path open by slight inflation of the microwavable cooking sheet, which can promote vapor movement around the food item(s) being cooked.

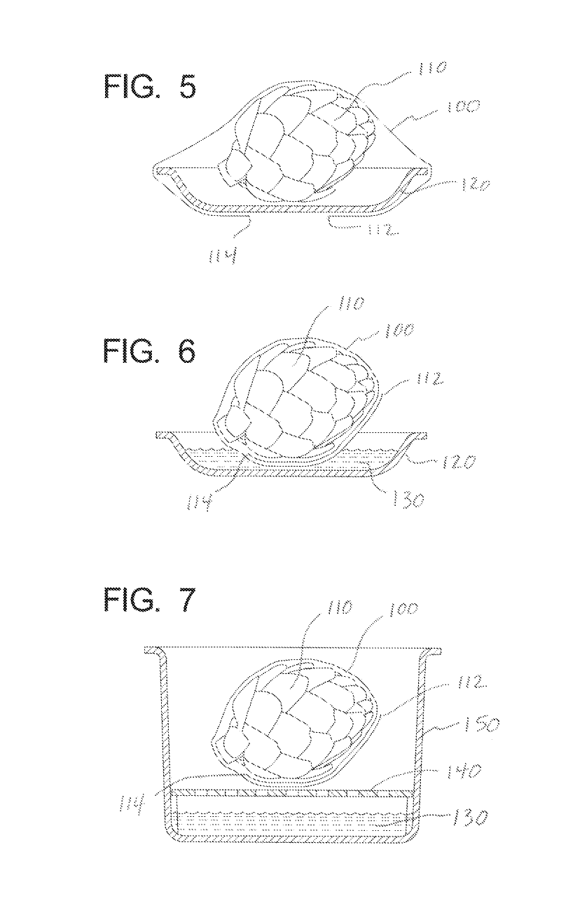

FIG. 5 is a cross-sectional view that illustrates another embodiment of the invention. In FIG. 5, the food item to be cooked 110 is placed in a bowl 120 and the microwavable cooking sheet 100 is wrapped around the food item 110 to be cooked. The ends 112, 114 of the microwavable cooking sheet are wrapped under the bowl to completely contain the food item to be cooked 110 between the microwave cooking sheet 100 and the bowl 120. In this case, a user would generally wet the microwaveable cooking sheet before use and then wring it out (or let excess moisture drip off). In one embodiment, the user does not wet the microwavable cooking sheet before cooking, such as, for example, if the moisture content of the food item to be cooked is high. In one embodiment, water (or some other liquid) may be placed in the bowl 120 and a portion of the food item to be cooked 110 may (or may not) be placed in the water (or liquid).

FIG. 6 is a cross-sectional view that illustrates another embodiment of the invention. The embodiment of FIG. 6 is similar to embodiment shown in FIG. 4, except that the bowl 120 has water 130 therein and the microwavable cooking sheet 110 is in contact with the water 130 in the bowl 120. The microwavable cooking sheet 100 has wicking properties which allows it to draw moisture from the bowl 120 during the microwave cooking cycle, so that sufficient moisture is provided to the food item being cooked 110. The wicking and moisture-retention properties of the microwavable cooking sheet 100 keep it sufficiently moist during the cooking process for extended periods of time.

FIG. 7 is a cross-sectional view that illustrates yet another embodiment of the invention. The embodiment of FIG. 7 is similar to the embodiment shown in FIG. 6, except that the food item to be cooked that is wrapped in the microwavable cooking sheet 100 is suspended above the water by a porous suspension mechanism 140 and the container 150 is both larger and taller than the bowl 120.

In the embodiments of FIGS. 6 and 7, the bowl 120 or container 150 may be adapted to receive a liquid such as, but not limited to, water and/or a substance that may change to a liquid upon heating such as, but not limited to, butter. The bowl 120 or container 150 may also be adapted the receive the food item to be cooked 110 after, or even before, receiving the liquid, and after the food item to be cooked 110 is wrapped with the microwavable cooking sheet 100.

In one embodiment, the bowl 120 or container 150 may comprise a microwavable-safe material such as, but not limited to, a ceramic material or ceramic blend material or glass or plastic, etc. In one embodiment, the amount of water placed in the bowl 120 or the container 150 may be dependent upon the size and type of food item to be cooked 110 and the size of the bowl 120. For example, in one embodiment, the food item to be cooked 110 may comprise a vegetable. One type of vegetable, such as, but not limited to, an artichoke, may need greater or lesser water for proper cooking than another vegetable type—such as, but not limited to, broccoli. Similarly, varying sizes of food items to be cooked 110, cooking times for such food items, and desired cooking levels for such food items—e.g., al dente, or otherwise, may determine the amount of water to place in the bowl 120 or container 150 prior to cooking. It is contemplated that the size of the bowl 120 or container 150 may be relative to the amount of water the bowl 120 or container 150 is to receive. In a first example, if the amount of water needed to cook the food item to be cooked 110 is 3 oz., a bowl 120 adapted to hold the 3 oz. of water, the food item to be cooked 110 and the microwavable cooking sheet 100 may be used. However, in a second example, if the water needed to cook the food item to be cooked 110 is 12 oz., the bowl 120 may be larger than the bowl 120 in the first example. Various bowl 120 and container 150 shapes are contemplated.

Upon filling the bowl 120 with water 130, wrapping the food item to be cooked 110 with the microwavable cooking sheet 100 and placing the food item to be cooked 110 in the bowl 120, the bowl 120 may be placed in a microwave and heated for a desired period of time to obtain the desired cooking level.

In one embodiment, each of the plurality of vegetables or other types of food items to be cooked 110 may be individually wrapped in a microwavable cooking sheet 100. In one such embodiment, individual portions of the bowl 120 may be adapted to receive the individually-wrapped food items to be cooked 110. Also, the microwavable cooking sheet 100 may be wetted either prior to placing the food item(s) to be cooked 110 on the microwavable cooking sheet 100, or after the food item(s) to be cooked 110 is wrapped and before or after the food item(s) to be cooked 110 is placed in the bowl 120.

In one embodiment, the microwavable cooking sheet 100 may comprise a thickness and a strength adapted to wrap snugly around a food item to be cooked 110 without the microwavable cooking sheet 100 being ripped, creating holes therein, or otherwise being modified in a manner preventing the microwavable cooking sheet 100 from working to cook the food item to be cook 110 to the desired cooking level.

In one embodiment, the microwavable cooking sheet 100 may include a woven material. In one embodiment, the microwavable cooking sheet 100 may include a non-woven material.

In using the microwavable cooking sheet 100 to cook a food item to be cooked 110, the microwavable cooking sheet 100 may comprise a disposable single-use material. In such an embodiment, the microwavable cooking sheet 100 may be disposed of after a single use. Disposing the microwavable cooking sheet 100 after each use instead of reusing the microwavable cooking sheet 100 may decrease the likelihood that food particles from prior uses will remain on the microwavable cooking sheet 100 and contact the food in a subsequent use, thereby creating a more sanitary product. In some instances, however, the microwavable cooking sheet 100 may be used multiple times over a relatively short period of time (e.g., when multiple food items to be cooked 110 are being prepared for a single meal).

In one embodiment, the microwavable cooking sheet 100 comprises a flexible woven fabric material. Again, the microwavable cooking sheet 100 may take numerous different sizes and shapes. For example, in one embodiment, the microwavable cooking sheet may be comprised of about a 16.5″×16.5″ fabric. Alternative sizes are certainly anticipated, including sizes from about 4″×4″ to about 48″×48″ (or similar sized round, elliptical or rectangular sheets, among other shapes).

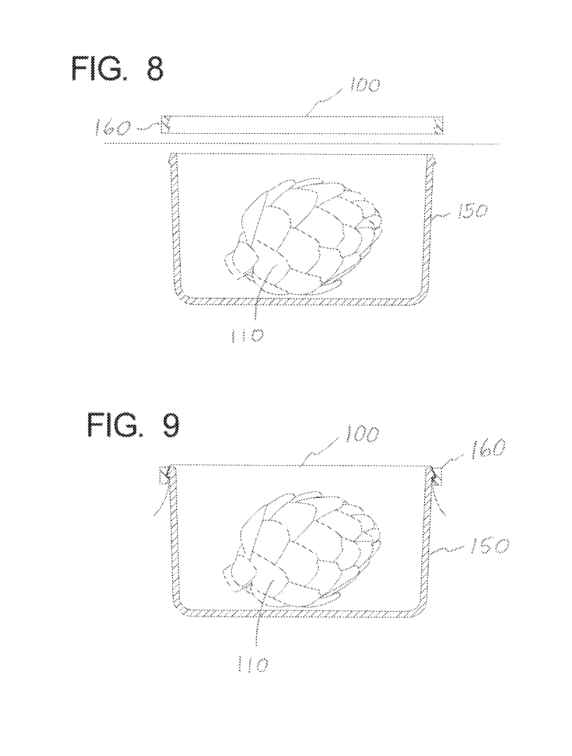

FIGS. 8 and 9 are cross-sectional views that illustrate an additional embodiment of the invention, which is similar to the embodiment shown in FIG. 7. The embodiment of FIGS. 8 and 9 differs from the embodiment of FIG. 7 in that the container 150 includes an annular ring 160 which engages the microwavable cooking sheet 100 to completely enclose the food item to be cooked 110 between the microwavable cooking sheet 100 and the container 150. Furthermore, no water is provided at the bottom of the container 150 (although it could be and, likely, would be). In addition, the food item to be cooked 110 is not wrapped in a microwavable cooking sheet 100 (although it could be).

In use, the food item to be cooked 110 is placed in the container 150. Next, the microwavable cooking sheet 100 is stretched over container 150. Then, the ring 160 is placed over cooking sheet and is moved downwardly, so that it engages the container 150. Subsequently, the entire container 150 is placed into microwave. The cooking sheet 100 may be wetted before or after it is placed onto the container 150.

It should be noted that one or more of the devices, methods, and systems described herein are adapted to work with frozen food items such as, but not limited to, frozen vegetables. In one embodiment, water (or some other liquid) is added to the vegetables before they are frozen. In such case, little or no additional water is needed when using the microwavable cooking sheet 100 of the present invention. In one embodiment, no water is added prior to freezing the food because the food has suitable moisture content.

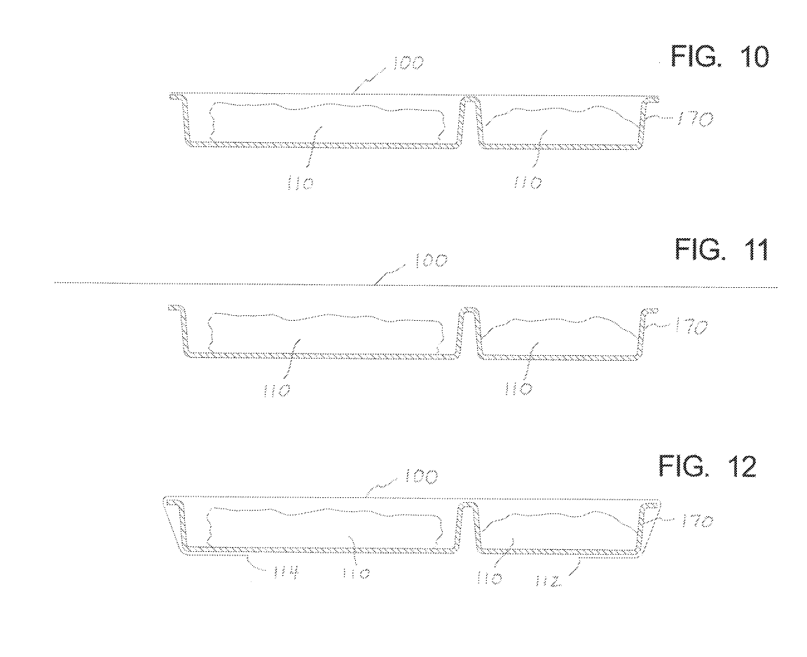

FIG. 10 illustrates yet a further embodiment of the invention, wherein the microwavable cooking sheet 100 is affixed to the tray 170 of a frozen dinner. The microwavable cooking sheet 100 may be affixed to the tray 170 by, for example, sonic welding, adhesives, heat sealing or crimping. In one embodiment (not shown, but readily understandable to one skilled in the art), the microwavable cooking sheet 100 is completely wrapped around the tray 170.

In one embodiment, the microwavable cooking sheet 100 is wetted before it is affixed to the tray 170 and is then frozen with the rest of the frozen dinner. In one embodiment, the microwavable cooking sheet 100 is wetted after it is affixed to the tray 170 and then is frozen with the rest of the frozen dinner. In one embodiment, the microwavable cooking sheet 100 is not wetted prior to freezing the frozen dinner, but is wetted just prior to cooking the frozen dinner. In one embodiment, the food item to be cooked 110 has enough water added to it just prior to it being frozen, such that there is no additional need to wet the microwavable cooking sheet 100 prior to cooking the frozen dinner in the microwave.

When, as in prior devices, a thin sheet of plastic film is used for a frozen dinner, the user is required to make a slit or opening in the film. Failing to do so might cause an explosion to occur, since pressure might build up between the plastic film and tray. In contrast, the microwavable cooking sheet 100 of the present invention does not require a slit or opening to be formed therein by a user, because the microwavable cooking sheet 100 is a self-venting material. Accordingly, not enough pressure is built-up to create an explosion.

FIGS. 11 and 12 are cross-sectional views that illustrate yet an even further embodiment of the invention, wherein the microwavable cooking sheet 100 is wrapped around the tray 170 of a frozen dinner, so that the food item(s) to be cooked 110 are completely contained between the tray 170 and the microwavable cooking sheet 100. It should be understood that the microwavable cooking sheet 100 may or may not be wetted prior to use.

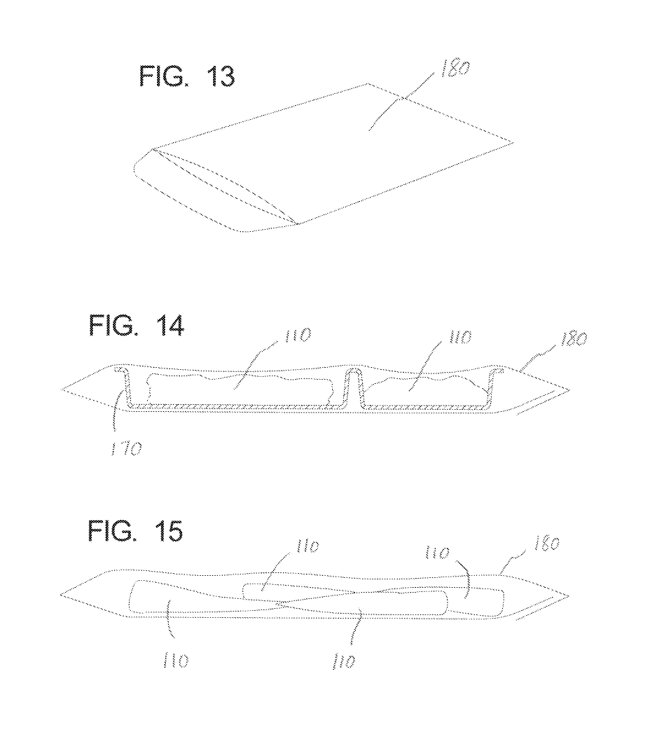

FIG. 13 is a perspective view that illustrates yet another exemplary embodiment of the invention, where the microwavable cooking sheet 100 is in the form of an envelope 180. As illustrated in FIG. 14, the embodiment of the microwavable cooking sheet 100 (which is comprised of a single layer) is useful for cooking frozen dinners.

Specifically, FIG. 14 is a cross-sectional view that illustrates a food tray 170 that has had its plastic cover removed and which has been inserted into the envelope-shaped microwavable cooking sheet 180 of FIG. 13, so that the envelope-shaped microwavable cooking sheet 180 completely contains the food items 110 to be cooked, which are located in the cooking tray 170. Again, the microwavable cooking sheet 180 may or may not be wetted before cooking the food items 110.

As shown in FIG. 15, the envelope-shaped microwavable cooking sheet 180 of FIG. 13 may be used to cook food items without use of a tray. Specifically, FIG. 15 shows food items to be cooked 110 which have been inserted into the microwavable cooking sheet 180 of FIG. 13, so that the microwave cooking sheet 180 completely contains the food items to be cooked. The food items to be cooked 110 may be frozen, fresh or leftovers. The microwavable cooking sheet 180 may or may not be wetted before cooking the food items 110.

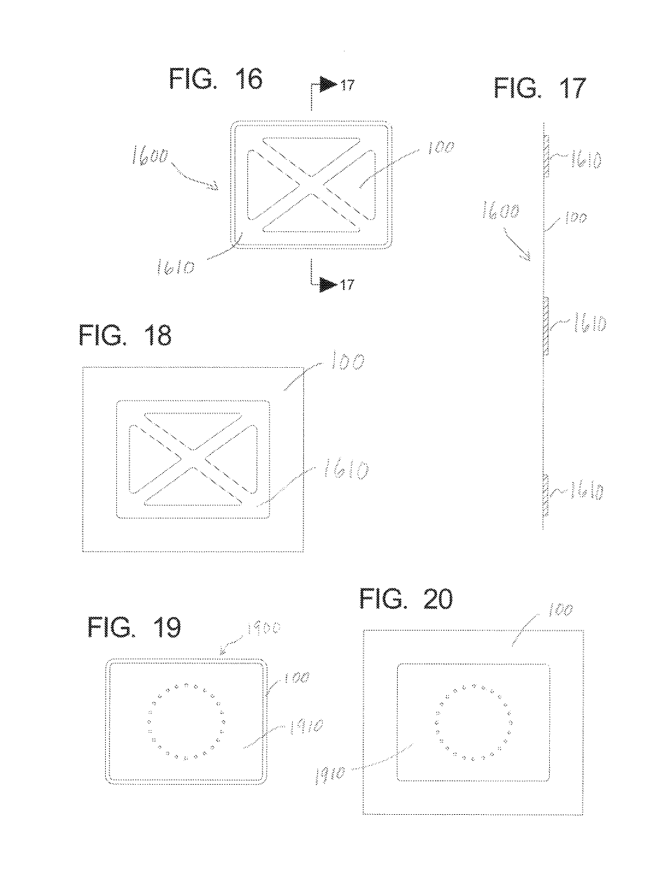

FIGS. 16 and 17 illustrate a microwavable cooking sheet 1600 that includes a primary material 100 (the same types of materials as in earlier embodiments) and an optional lattice 1610 attached thereto. In one embodiment, the lattice 1610 is made of plastic, although it may be made of other materials (e.g., paper). The lattice 1610 is provided to add strength to the microwavable cooking sheet 1600 relative to using the primary material 100 alone. In one embodiment, the lattice 1610 may be flexible if, for example, the microwavable cooking sheet 1600 is being used to wrap around food items to be cooked. On the other hand, the lattice 1610 may be semi-rigid or rigid, for example, if the microwavable cooking sheet 1600 is affixed to the top of a frozen dinner tray.

FIG. 18 is a view similar to FIG. 16, except that the size of the lattice 1610 is smaller in size relative to the size of the primary material 100 of the microwavable cooking sheet 1600. The embodiment of the microwavable cooking sheet 1600 shown in FIG. 18 would allow the primary material 100 to be more easily wrapped around a frozen dinner tray or food item to be cooked.

It should be understood that the lattice 1600 may take a variety of forms. For example, in one embodiment, the lattice 1610 may be shaped like a mesh or netting.

FIG. 19 illustrates a microwavable cooking sheet 1900 that includes a primary material 100 (the same types of materials as earlier embodiments) and an optional perforated plastic film 1910 attached thereto. The plastic film 1910 is provided to add strength to the microwavable cooking sheet 1900 relative to using the primary material 100 alone. In one embodiment, the plastic film 1910 seals the tray from the environment prior to cooking, yet enables the primary material 100 to control the cooking environment.

Furthermore, using a plastic film 1910 may cause pressure to be built-up between the food item to be cooked 110 and the primary material 100. The perforations in the plastic film 1910, along with the strength and thickness of the plastic film 1910, are designed to cause the plastic film 1910 to burst at around a particular pressure selected by the designer. Although the plastic film 1910 would burst at the perforations, the primary material 100 would remain intact. In one embodiment, the plastic film 1910 would be more loosely attached to the primary material 100 near the perforations.

In one embodiment, at least the primary material 100 of the microwavable cooking sheet 1900 is wetted before cooking the food items 110. In one embodiment, the entire microwavable cooking sheet 1900 is wetted before cooking the food items 110.

FIG. 20 is a view similar to FIG. 19, except that the size of the plastic film 1910 is smaller relative to the size of the primary material 100 of the microwavable cooking sheet. The embodiment of the microwavable cooking sheet 1900 shown in FIG. 20 would allow the primary material 100 to be more easily wrapped around a frozen dinner tray or food item to be cooked. It should be understood that the plastic film 1910 may take a variety of forms. For example, in one embodiment, the shape of the plastic film 1910 is circular, oval, polygonal or some other configuration. Furthermore, in one embodiment, the pattern of the perforations is non-circular (e.g., oval, polygonal, or some other shape).

The inventors have performed numerous tests of one embodiment of the present invention against both paper towels and plastic microwave wrap. Without wishing to be bound to any particular theory, the inventors have reached the following conclusions.

First, the moisture content of the microwavable cooking sheet used with the food item to be cooked is important because in relative terms—an ideal wrap moisture content is able to have just enough moisture to turn water (which was typically added to the microwavable prior to cooking) into steam in the vapor space of the cooking arrangement (e.g., on the portion out of the bowl but under the microwave cooking sheet) while the inside of the item being cooked is also being heated from the microwave energy. Ideally, the microwave cooking sheet will start “steaming” the moisture off either before or while the item is heating up—(heating up to approximate steam temperatures). Since the microwave energy goes both into the microwavable cooking sheet to generate steam, and into the internal moisture of the food item being cooked, and any remaining water in the cooking arrangement—the heating is more uniform than if there was no microwavable cooking sheet present and the steam would only escape.

Second, the inventors' testing indicates that higher than ideal moisture content will result a microwavable food wrap (e.g., a paper towel) remaining wet (even soggy) longer than when there is an ideal moisture content. This results in less steaming in the internal portion of the cooking arrangement from the wrap, while the inside of the item being cooked continues cooking at the same rate. Technically—what happens when there is too much moisture in a wrap—is that the microwave energy is not powerful enough to vaporize the moisture quickly, and the moisture in the wrap remains hot water longer. Ultimately, when there is too much moisture in the wrap—the “center” (middle) of the item being cooked cooks more than desired, while the outside of the item takes longer to cook, thereby resulting in less than ideal cooking quality. Thus, in this case, one typically ends up with over cooked centers to get the outside portions cooked ideally. This is exacerbated by having a paper towel where not only is extra moisture present, but when cooking, the steaming taking place in the outer layer will actually have an evaporative cooling effect on the inner wrap layer, so the inner layer will tend to run cooler than the outer layer. Thus, the water in the inner layer will remain as hot water instead of water vapor for a longer time.

However, the single layer microwavable cooking sheet of the present invention, when generating water vapor (steam), releases the steam to both sides (inside and outside) of the sheet. This increases the absorbed cooking energy on the item being cooked.

Third, paper towels are typically designed for absorbency. They have thin multi-layers of material that have more absorbency and tend to stay wet longer (when used as a food wrap in a microwave) than the microwavable cooking sheet of the present invention. Also, variations from brand-to-brand or paper towel “model” can result in significant changes in cooking quality since absorbency can change significantly. The microwavable cooking sheet of the present invention has an absorbency range that is below that of the paper towels that the inventors' tested.

Fourth, pressure retention is also important since it helps increase the steam temperature slightly while also giving resistance for the steam to escape the cooking area (between the microwavable cooking sheet and the food item being cooked). Paper towels have notable variations in pressure retention, where BOUNTY®, for example, has very little pressure retention (where vapor tries to pass through a wet BOUNTY® paper towel).

Fifth, in both cases (i.e., with an embodiment of the microwavable cooking sheet of the present invention and with a paper towel (or other absorbent material)), there is an advantage to having moisture surrounding the food item being cooked, as it helps keep the outside of the food item being cooked moist, because the item being cooked is surrounded by water in the absorbed material for at least some or most of the cooking cycle.

Sixth, plastic film wraps (such as, SARAN® wrap) lie on the extreme end of no absorbency or pressure retention. Since plastic film wraps have no outside moisture to start steaming, the places that can steam while cooking with plastic film wraps are: (1) in the food item itself; and, (2) any water that is in the cooking arrangement. The inventors' testing indicates that, typically, the food item heats very quickly and cooks mostly from the inside out. Minor heating occurs from the outside, as steam travels past the food item being cooked, as it vents through the gap in the plastic. Also, minor heating may occur from any water in the cooking arrangement that may be heating from the outside of the item. As one might expect, cooking with plastic film results in food that is easily overdone on the inside. Also, since there is minimal moisture retention, cooking with plastic film is also prone to excessive cooking in areas that lose moisture first, which results in dried out areas, especially on the outside.

Seventh, the inventors have concluded that the exact ideal moisture content varies depending on the specific moisture content and cooking time of the item being cooked, the power of the microwave, and the time necessary to cook the food item. For instance, a higher moisture content (absorbency) is typically desirable when using a more powerful microwave or when the item typically has low moisture content but requires a long cooking time. Because of this, the ability to adjust added water, via either water amount in the cooking device or wetness of wrap is important to the user's ability to properly cook a wide range of foods.

Embodiments of the present invention, including ranges specified by the inventors, account for the research they conducted.

The present invention may provide several advantages. For example, frozen vegetables may be crisper when using the microwavable cooking sheet of the present invention is used as opposed to cooking the vegetables in a microwave without using the present invention. Furthermore, the temperature of the food items to be cooked may also be more even across the entire portion of the food when using the present invention.

The present invention may also act as a medium to both help condense steam as it tries to leave the area where the food item is being cooked and to stop free water particles from leaving by trapping them. In one such embodiment, the moisture present in the moisture laden microwavable cooking sheet 100 may continue to receive energy from the microwave and actually aids in producing steam all around the food item being cooked, which may result in much more uniform and palatable food with a more natural texture, color, and taste.

The microwavable cooking sheet allows a small amount of pressure to build up in the area around where the food item is being cooked, which potentially aids in cooking by allowing a slightly higher steam temperature. Advantageously, the microwavable cooking sheet allows excess pressure to vent safely. In one embodiment, the pressure in may increase by at least about 3/16^{th} of an inch of H₂O, depending on moisture, density, and thickness of the microwavable cooking sheet.

It should be understood that, when using the term single layer, to define the microwavable cooking sheet, this does not mean that the microwavable cooking sheet cannot be wrapped over itself when wrapping food (see FIG. 3). Instead, single layer is intended to distinguish from paper towels, which have multiple layers and include thirst pockets, so as to increase absorbency.

In one embodiment, frozen dinners having the microwavable cooking sheet of the present invention attached thereto include a shrink wrap around the entire frozen dinner tray (including the microwavable cooking sheet), so as to seal the food, which can maintain freshness, maintain cleanliness and prevent tampering. The shrink wrap could be removed or cut prior to cooking the frozen dinner in the microwave.

Several embodiments of the invention have been described. It should be understood that the concepts described in connection with one embodiment of the invention may be combined with the concepts described in connection with another embodiment (or other embodiments) of the invention.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A method for cooking food in a microwave oven, the method comprising the steps of:
providing a microwavable cooking sheet, wherein the microwavable cooking sheet is comprised of a single layer of a primary material that is non-plastic, wherein the primary material has a weight of between 18 pounds per 3000 square feet and 60 pounds per 3000 square feet, wherein the primary material is porous, and wherein the primary material is capable of absorbing and retaining moisture;
wetting the microwavable cooking sheet, wherein the primary material is capable of absorbing and retaining sufficient moisture during the cooking time to provide moisture to the food during the cooking time;
wrapping the microwavable cooking sheet around the food;
cooking the food in the microwave oven for a cooking time with the wet material wrapped around the food, such that
a pressure increase of at least 3/16^{th} of an inch of H₂O is built-up within the microwavable cooking sheet,
the pressure increase is maintained for more than 25% of the cooking time; and
the porosity of the primary material allows excess pressure to vent.

2. The method of claim 1, wherein the step of wetting the microwavable cooking sheet is performed prior to wrapping the microwavable cooking sheet around the food.

3. The method of claim 1, wherein the step of wetting the microwavable cooking sheet is performed after wrapping the microwavable cooking sheet around the food.

4. The method of claim 3, wherein the step of wetting the microwavable cooking sheet includes providing a container having a liquid therein into which at least a portion of the microwavable cooking sheet is placed and wherein the microwavable cooking sheet has wicking properties, so that more than the portion of the microwavable cooking sheet that has been placed within the liquid becomes wet.

5. The method of claim 1, wherein the pressure increase is observed after at least 60 seconds of cooking.

6. The method of claim 1, wherein the pressure increase occurs for more than 35% of the cooking time.

7. The method of claim 1, wherein the primary material of the microwavable cooking sheet is biodegradable.

8. The method of claim 1, wherein the primary material of the microwavable cooking sheet is paper.

9. The method of claim 1, including the step of providing a container having a porous support mechanism and a liquid in the container that rests below the porous support mechanism, wherein the food wrapped in the microwavable cooking sheet is placed on the porous support mechanism prior to cooking.

10. The method of claim 1 further including the step of dispensing the microwavable cooking sheet from a roll.

11. The method of claim 10 further including the step of sizing the microwavable cooking sheet by cutting it with a blade or knife.

12. The method of claim 1, wherein the microwavable cooking sheet is pre-cut, folded and sold in a package containing a plurality of microwavable cooking sheets.

13. The method of claim 12, wherein the microwavable cooking sheets are wet when packaged.

14. The method of claim 1, wherein the pressure increase occurs for more than 50% of the cooking time.

15. The method of claim 1, wherein the pressure increase is maintained for at least 45 seconds.

16. The method of claim 1, wherein the pressure increase is maintained for at least 90 seconds.

17. The method of claim 1, wherein the microwavable cooking sheet has wicking properties.
